(19) United States
(12) Patent Application Publication
(10) Pub. No.: US 2025/0254540 A1
(43) Pub. Date: Aug. 7, 2025

(54) INDICATING MODEL PARAMETERS FOR CONTINUAL LEARNING OF COMMUNICATIONS NETWORK MODELS

(71) Applicant: Lenovo (United States) Inc., Morrisville, NC (US)

(72) Inventor: Venkata Srinivas KOTHAPALLI, Aurora, IL (US)

(21) Appl. No.: 19/184,744

(22) Filed: Apr. 21, 2025

(51) Int. Cl. H04W 24/02; G06N 5/04

(52) U.S. Cl. CPC H04W 24/02; G06N 5/04

(57) ABSTRACT

Various aspects of the present disclosure relate to adapting (or updating) an artificial intelligence/machine learning (AI/ML) model (e.g., a deep neural network) to unknown/new target domains while minimizing any loss of knowledge of previous domains within which the model was deployed or adapted. For example, an adaptation procedure may determine or identify knowledge intensive (e.g., important) parameters of the model and adapt the model to a new domain while minimizing changes to values of the knowledge intensive parameters. The procedure may determine a metric for each parameter of the model (e.g., a knowledge coefficient or importance metric) and minimize changes to values of any parameters having relatively high importance metrics during adaptation/updating of the model.

### TECHNICAL FIELD

The present disclosure relates to wireless communications, and more specifically to indicating model parameters for continual learning of communications network models, such as artificial intelligence/machine learning (AI/ML) models.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support or implement indicating model parameters for continual learning of communications network models, such as artificial intelligence/machine learning (AI/ML) models.

A first node for wireless communication is described. The first node may be configured to, capable of, or operable to perform one or more operations as described herein. For example, the first node may comprise at least one memory and at least one processor coupled with the at least one memory and configured to cause the first node to determine, for an AI/ML model, a set of knowledge intensive model parameters from a set of model parameters associated with the AI/ML model and based on a set of labeled data samples and transmit, to a second node, an indication of the set of knowledge intensive model parameters.

A method performed or performable by the first node is described. The method may comprise determining, for an AI/ML model, a set of knowledge intensive model parameters from a set of model parameters associated with the AI/ML model and based on a set of labeled data samples and transmitting, to a second node, an indication of the set of knowledge intensive model parameters.

In some implementations of the first node and method described herein, to determine the set of knowledge intensive model parameters, the first node and method may further be configured to, capable of, performed, performable, or operable to determine a knowledge coefficient value for each parameter in the set of model parameters and select a parameter in the set of model parameters as a knowledge intensive model parameter when an associated knowledge coefficient value is above a threshold value.

In some implementations of the first node and method described herein, to determine the set of knowledge intensive model parameters, the first node and method may further be configured to, capable of, performed, performable, or operable to compute K number of gradient values with respect to the parameter, wherein a gradient value corresponds to a distinct data sample in the set of labeled data samples, compute K absolute values by computing an absolute value for each of the K number gradient values, compute an average value of the computed K absolute values, and determine the average value as the knowledge coefficient value for each parameter.

In some implementations of the first node and method described herein, the first node and method may further be configured to, capable of, performed, performable, or operable to receive the set of labeled data samples from a network node different from the second node.

In some implementations of the first node and method described herein, the first node and method may further be configured to, capable of, performed, performable, or operable to receive the set of labeled data samples based on reference signals received from a network node different from the second node.

In some implementations of the first node and method described herein, to transmit the indication of the set of knowledge intensive model parameters, the first node and method may further be configured to, capable of, performed, performable, or operable to transmit an indication that identifies one or more parameters of the set of model parameters as being part of the set of knowledge intensive model parameters.

A second node for wireless communication is described. The second node may be configured to, capable of, or operable to perform one or more operations as described herein. For example, the second node may comprise at least one memory and at least one processor coupled with the at least one memory and configured to cause the second node to receive, from a first node, an indication of a set of knowledge intensive model parameters, wherein the set of knowledge intensive model parameters are selected from a set of model parameters associated with an AI/ML model and update the AI/ML model based on a set of data samples and by minimizing updates to the set of knowledge intensive model parameters.

A method performed or performable by the first node is described. The method may comprise receiving, from a first node, an indication of a set of knowledge intensive model parameters, wherein the set of knowledge intensive model parameters are selected from a set of model parameters associated with an AI/ML model and updating the AI/ML model based on a set of data samples and by minimizing updates to the set of knowledge intensive model parameters.

In some implementations of the first node and method described herein, to update the AI/M model by minimizing updates to the set of knowledge intensive model parameters, the second node and method may further be configured to, capable of, performed, performable, or operable to compute and minimize a loss function based on the set of data samples.

In some implementations of the first node and method described herein, the second node and method may further be configured to, capable of, performed, performable, or operable to cause the second node to receive the set of labeled data samples from a network node different from the first node.

In some implementations of the first node and method described herein, the second node and method may further be configured to, capable of, performed, performable, or operable to receive the set of labeled data samples based on reference signals received from a network node different from the first node.

In some implementations of the first node and method described herein, the second node and method may further be configured to, capable of, performed, performable, or operable to determine whether to update the AI/ML model based on receiving an indication of a periodic update interval.

In some implementations of the first node and method described herein, the second node and method may further be configured to, capable of, performed, performable, or operable to determine whether to update the AI/ML model based on receiving an indication or configuration from a network node different from the first node.

In some implementations of the first node and method described herein, the second node and method may further be configured to, capable of, performed, performable, or operable to determine whether to update the AI/ML model based on changes in characteristics of the set of data samples.

In some implementations of the first node and method described herein, the second node and method may further be configured to, capable of, performed, performable, or operable to determine whether to update the AI/ML model based on a change in conditions of a communications network associated with the second node.

In some implementations of the first node and method described herein, the second node and method may further be configured to, capable of, performed, performable, or operable to determine whether to update the AI/ML model based on receiving an indication, from the first node, that indicates a quality of performance of the AI/ML model at the first node.

In some implementations of the first node and method described herein, a knowledge intensive model parameter is associated with a knowledge coefficient value above a threshold value.

### BRIEF DESCRIPTION OF THE DRAWINGS

FIG. 1 illustrates an example of a wireless communications system in accordance with aspects of the present disclosure.

FIG. 2 illustrates example communications between a first node and a second node in accordance with aspects of the present disclosure.

FIG. 3 illustrates an example procedure of determining a knowledge coefficient value in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by a UE or an NE in accordance with aspects of the present disclosure.

FIG. 8 illustrates a flowchart of a method performed by a UE or an NE in accordance with aspects of the present disclosure.

### DETAILED DESCRIPTION

The present disclosure relates to methods, apparatuses, and systems that provide, support, implement, and/or introduce continual learning of communications network models by training the models using knowledge intensive or other subsets of model parameters.

Wireless communications systems may adopt AI/ML techniques for building efficient modules within their transmitter-receiver chains. For example, a network may utilize AI/ML models, such as deep neural networks (DNNs) for a variety of functions, such as channel state information (CSI) compression, beam prediction/positioning, and so on. An AI/ML model may include algorithms having learnable parameters (e.g., a support vector machine or decision tree), neural networks (NNs) with neuron weights as learnable parameters, and so on.

When deployed in a real-world environment (e.g., at a base station), the AI/ML models are useful when performing with a same level of accuracy/precision (e.g., by providing desired inferences/predictions) as performed during training and testing phases before the deployment. However, such AI/ML models may perform using different statistical characteristics than during the training/testing phases, which may lead to a performance of erroneous or wrong inferences/predictions. While in theory a generalized AI/ML model may be adaptable across different environments, a useful generalized AI/ML model that can generalize all or many possible domains and suitably perform across the domains (e.g., especially in the context of wireless networks, which exhibit varying dynamics in the statistics of its data distributions) is not practical.

An AI/ML model, such as a DNN, may be trained on a first set of data samples (e.g., a source domain) and deployed in a different domain (e.g., a target domain) to make inferences/predictions using a second set of data samples. It follows that an AI/ML model f_{W}, which learned and is trained over source domain data samples may not perform with sufficient fidelity in making inferences/predictions while operating with input samples from a target domain (e.g., where the input samples have different distributions).

Thus, adaptation of AI/ML models, such as DNNs, is useful when statistical characteristics of incoming data or of an environment of deployment change. The adaptation of a DNN may entail adapting the parameters of the DNN such that an adapted version of the DNN outputs desired predictions/inferences when deployed in a target domain. However, once adapted, the DNN (or other AI/ML model) may lose its ability to perform predictions/inferences for previous or old domains. In other words, once a DNN is adapted for a target domain, it may not be useful for deployment to other domains, such as previous or old domains within which the model was previously deployed. The AI/ML model, therefore, may lose certain knowledge characteristics or usefulness as it is deployed (and adapted) from one domain to another domain.

For example, a DNN may be deployed to perform beam selection for a base station. The DNN may be adapted to work in a certain target domain (e.g., a dense urban environment with many reflectors and rich multipath scattering). However, once adapted, the DNN may be insufficient for deployment in a previous domain (e.g., an environment having a rural channel with minimal reflectors). As another example, a DNN may be deployed to assist in decoding communications between network nodes. The DNN may be adapted to decode/demodulate symbols received over a benign channel with a strong line of sight (LoS) component and minimal reflectors. However, the DNN may not be useful for other domains, such as a domain having a rich scattering channel without any LoS component.

The technology described herein facilitates the adaptation (or updating) of an AI/ML model (e.g., a DNN) to unknown/new target domains while minimizing any loss of knowledge of previous domains within which the model was deployed or adapted. An adaptation procedure may determine or identify knowledge intensive (e.g., important) parameters of the model and adapt the model to a new domain while minimizing changes to values of the knowledge intensive parameters. For example, the procedure may determine a metric for each parameter of the model (e.g., a knowledge coefficient or importance metric) and minimize changes to values of any parameters having relatively high importance metrics during adaptation/updating of the model.

Once adapted, the model may be deployed for use in the target domain, while maintaining its usefulness for deployment or use in previous or future data domains. Thus, the adaptation procedure (or updating procedure) may maintain certain parameter values while the model is adapted for a target domain, to prevent or mitigate losing the trained or acquired knowledge of the model, among other benefits.

Aspects of the present disclosure are described in the context of a wireless communications system.

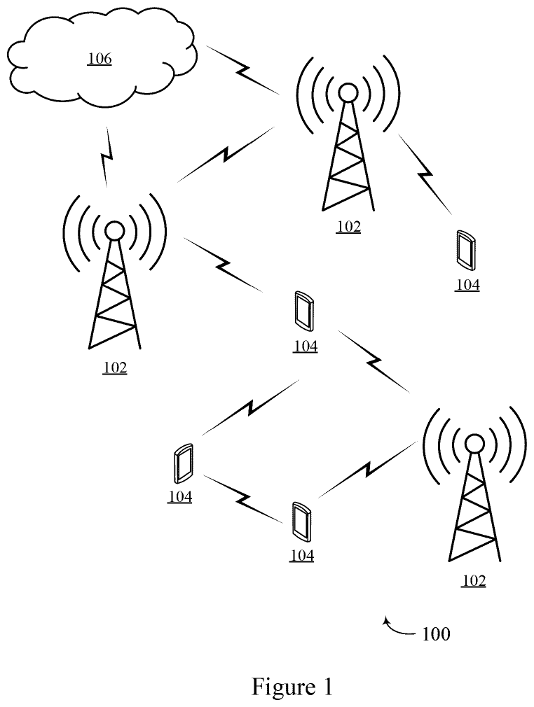

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the technology provides for the use of AI/ML models (e.g., DNNs) within various target domains of the wireless communications system 100. Example models include models that perform regression, classification, and so on. Further, the adaptation procedures described herein may be utilized by various AI/ML models and DNNs used within wireless networks, such as models deployed for beam management, encoding/decoding communications, and so on.

In some cases, the parameters of a DNN may not be equally knowledgeable, useful, important, or significant when determining the output of the DNN when the DNN is trained on a particular data domain (e.g., [symbol] ^{s}={(xᵢ^{s}, yᵢ^{s})}ᵢ₌₁ⁿ˜P_{XY}^{s}) or when the DNN is trained for a particular task. For example, some (a subset) of the parameters or some (a subset) of the neuron weights (for a DNN) may have a dominant/influential/significant role or factor in determining the output of the DNN to an input data sample when the DNN is trained over a data domain (e.g., [symbol] ^{s}). Parameters or neurons may be knowledgeable (or knowledge intensive) when associated with or exhibiting a higher sensitivity to the input data samples and/or when influencing the DNN output at a relatively higher level than other neurons/parameters.

For example, in a DNN trained over a data domain [symbol] ^{s}={(xᵢ^{s}, yᵢ^{s})}ᵢ₌₁ⁿ˜P_{XY}^{s}, with optimal model parameters given by W=[w₁, . . . , w_{N}]^{T}∈ [symbol] ^{N}, the prediction/inference performance of the DNN may be dominated highly influenced by some of the parameters in W=[w₁, . . . , w_{N}]^{T}, referred to as knowledge intensive parameters, influential parameters, important parameters, or other parameters relatively more dominant with respect to the performance of the DNN. In other words, some parameters (e.g., the knowledge intensive parameters) acquire more knowledge regarding performance on a source domain [symbol] ^{s} and exhibit more important/influential/dominant role in deciding the output of the DNN.

Thus, the change of a value of a knowledge intensive parameter in a DNN (e.g., by a small amount from its optimal value (e.g., its learned/trained value)) may significantly change the predictions/inferences/performance of the DNN. On the other hand, other parameters may not be influential/important/dominant and the prediction/inference/performance of the DNN does not significantly change when the values these parameters changes. In some cases, knowledge intensive parameters may be strong parameters while other parameters may be weak parameters, with respect to resulting changes to the performance of a DNN.

In some examples, a network node (e.g., the UE 104 and/or the NE 102, such as a base station) may determine a knowledge coefficient for some or all parameters in a DNN (or, in general, an AI/ML model), such as a DNN that has finished a training phase. For example, a DNN (f_{W}) is trained to perform one or more tasks on one or more data domains and has optimal parameters given by W={wⱼ}ⱼ₌₁^{N} (or denoted as a vector W=[w₁, . . . , w_{N}]^{T}). The sensitivity or the importance of a parameter wⱼ, 1≤j≤N, of the DNN f_{W}, with W={wⱼ}ⱼ₌₁^{N} as its optimal parameters, may be determined by computing:

$${β}_{j} = \frac{1}{{N}_{tr}} {\sum }_{i = 1}^{{N}_{tr}} \vert \frac{\partial L ( W , {𝒟}_{tr}^{s}}{\partial {w}_{j}} \vert = \frac{1}{{N}_{tr}} {\sum }_{i = 1}^{{N}_{tr}} \vert \frac{\partial L ( {f}_{W} ( {x}_{i}^{s} ) , {y}_{i}^{s} )}{\partial {w}_{j}} \vert$$

Where

$$\frac{\partial L ( {f}_{W} ( {x}_{i}^{s} ) , {y}_{i}^{s} )}{\partial {w}_{j}}$$

is a gradient of a loss function with respect to wⱼ at input sample xᵢ^{s}, and [symbol] ₜᵣ^{s}={(xᵢ^{s}, yᵢ^{s})}ᵢ₌₁^{N}^{ₜᵣ}˜P_{XY}^{s} denotes the set of labeled data samples from source domains s (where xᵢ^{s}∈χ and yᵢ^{s}∈ [symbol] denote an input sample and the corresponding label, respectively) used for training the DNN, and |Z| denotes an absolute value of Z.

The value of βⱼ is the knowledge coefficient, which may be a measure of the importance/influence of the parameter wⱼ in determining the model output over the data domain [symbol] ₜᵣ^{s}, as described herein. When the value of βⱼ is higher for a particular parameter wⱼ, then the parameter wⱼ is a knowledge intensive parameter (or as an important/influential parameter).

As described herein, the knowledge intensive parameters of a DNN may significantly influence the inference/prediction made by the DNN, and these knowledge intensive/important/influential parameters represent key learnings of the DNN when it was trained over the data domain [symbol] ₜᵣ^{s}. In other words, the knowledge intensive/important/influential parameters may contain the most important knowledge learned by the DNN to make correct inferences/predictions when it receives an input data sample from the data domain [symbol] ₜᵣ^{s}˜P_{XY}^{s}.

As a first example, a DNN may include multiple batch normalization layers. As described herein, parameters/weights of the batch normalization layers may be part of a set of knowledge intensive/important/influential parameters of the DNN, because the batch normalization layers adjust the data distribution as the input data samples propagate through the DNN. In other words, the batch normalization layers provide internal corrections to a covariate shift of the data samples as they move across the network from one layer to the other. Thus, as described herein, the parameters of the batch normalization layers are knowledge intensive as they hold the key knowledge acquired by the DNN from the data domain over which it was trained.

As a second example, convolution layers may be more knowledge intensive/important/influential than feed-forward layers because the parameters of the convolution layers act upon the data samples more than once while the feed-forward layers only effect the input data samples one time.

As a third example, in an image classifier DNN with convolution layers (e.g., ResNet34), the lower (e.g., the initial, the first few) layers may be more knowledge intensive/important/influential than higher (or later) layers, because the lower layers extract the features of input images and thus may highly or dominantly influence the output of the DNN.

As a fourth example, for a classifier designed using a prototypical NN, the last layer may be more knowledge intensive/important/influential as it includes the prototypes or the classification vectors, and prototypical NNs may be adapted by only adapting their last layers.

In some examples, an adaptation procedure, as described herein, may adapt a DNN to acquire new knowledge while minimizing knowledge losses from past deployments. Once knowledge coefficients of the parameters of a DNN (or another AI/ML model) are determined, the DNN (or the AI/ML model) may be adapted/updated by restricting or constraining updates of each parameter value of the DNN based on the determined knowledge coefficients.

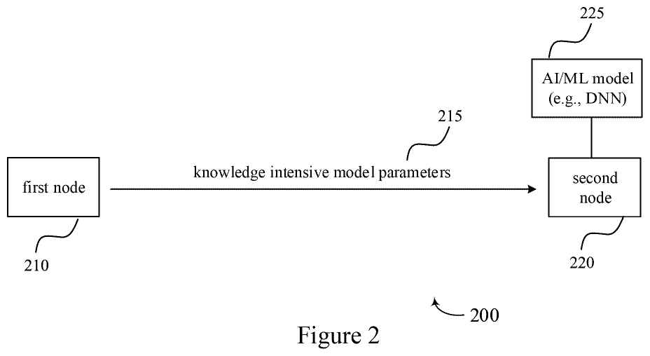

FIG. 2 illustrates example communications 200 between a first node and a second node in accordance with aspects of the present disclosure. As described herein, a first node 210 may determine a set of knowledge intensive model parameters 215 from a set of model parameters associated with an AI/ML model 225 and based on a set of labeled data samples. The first node 210 may transmit to a second node 220 an indication of the set of knowledge intensive model parameters 215. The second node 220, which is deploying the AI/ML model 225 (in a target domain), may update the AI/ML model 225 based on a set of data samples (e.g., domain data in the target domain) and by minimizing updates to the set of knowledge intensive model parameters 215.

In some cases, the first node 210 is the UE 104 and the second node 220 is the NE 102 (e.g., a base station). However, in various cases, the first node 210 may be the NE 102 and the second node may be the UE 104. Thus, the first node 210 and/or the second node 220 may be any network node or user device that trains, adapts, or deploys the AI/ML model 225 when performing network functions, as described herein.

In some cases, when minimizing updates to the set of knowledge intensive model parameters 215, the second node 220 may update/adapt a value of parameters without deviating from an original or optimal value. Such a restriction on the updated/adapted values of the knowledge intensive model parameters 215 of the AI/ML model 225 may facilitate knowledge retention by the AI/ML model 225 while also being trained using new data samples.

When the knowledge coefficient/importance of a parameter is a low value, then the updated/adapted value of that parameter may deviate from its original value, because the low knowledge parameters contain a limited amount of the knowledge learned by the AI/ML model 225 from past domains. Thus, changing the values of these parameters does not result in a considerable loss of past or acquired knowledge of the DNN. These parameters may then learn from the target domain, and the second node 220 may adap/update their values without (or with minimal) constraints or restrictions.

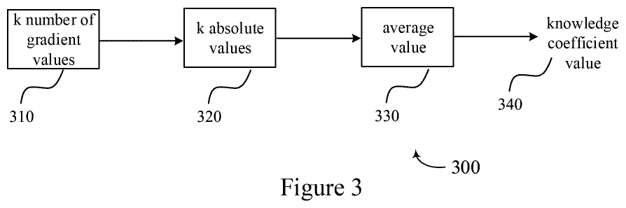

FIG. 3 illustrates an example procedure 300 of determining a knowledge coefficient value in accordance with aspects of the present disclosure. The procedure 300 may be performed to determine a knowledge coefficient value for each parameter in the set of model parameters and/or select a parameter in the set of model parameters as a knowledge intensive model parameter when an associated knowledge coefficient value is above a threshold value.

For example, the first node 210 may compute K number of gradient values 310 for a model parameter, where a gradient value corresponds to a distinct data sample in a set of labeled data samples, compute K absolute values 320 by computing an absolute value for each of the K number gradient values 310, compute an average value 330 of the computed K absolute values, and determine or assign the average value 330 as a knowledge coefficient value 340 for each parameter.

As described herein, the second node 225 may determine the optimal model parameters for a DNN (e.g., the AI/ML model 225) determined by minimizing an objective function, such as a loss function, as follows.

Let a DNN be denoted by the function, f_{W}, where f_{W}: χ→ [symbol] . Here, W={wᵢ}ᵢ₋₁^{N} denotes the set of optimal model parameters of the DNN that are learned during an initial training over a source domain data (denoted by [symbol] ₜᵣ^{s}={(xᵢ^{s}, yᵢ^{s})}ᵢ₌₁^{N}^{ₜᵣ}˜P_{XY}^{s}). These parameters are to be adapted/updated based on target domain data. The supervised learning/training of a DNN may entail minimizing a loss function L, where the set of optimal parameters W is determined by solving the following optimization problem:

$$W = {min}_{{W}^{′} ∈ {ℝ}^{N}} L ( {W}^{′} , {𝒟}_{tr}^{s} )$$

The adapted/updated DNN is denoted by the function, f_{W}_{ₐ}, where Wₐ={W_{a,i}}ᵢ₌₁^{N} denotes the set of optimal model parameters of the DNN after the adaptation. The optimal model parameters after adaptation (e.g., the updated model parameters) can be determined as follows:

$${W}_{a} = {min}_{{W}_{a}^{′} ∈ {ℝ}^{N}} [ L ( {W}_{a}^{′} , {D}^{t} ) + λ {\sum }_{j = 1}^{N} {{β}_{j} ( {w}_{a , j}^{′} - {w}_{j} )}^{2} ]$$

Where [symbol] ^{t}={(xᵢ^{s}, yᵢ^{s})}ᵢ₌₁ⁿ˜P_{XY}^{t} are the labeled data samples from the target data domain, λ is a hyper parameter, wⱼ denotes old parameters of the DNN. Thus, the model/DNN is adapted to the new data domain D^{t} (e.g., adapted to learn a new task), by changing the parameters of the model that are not important/influential/dominant with respect to a previous data domain [symbol] ₜᵣ^{s} or a previous task.

In some examples, the second node 220 determines to update (or not update) the AI/ML model 225 based on a variety of factors. For example, the second node 220 may update the model based on receiving an indication of a periodic update interval or time window (e.g., associated with a continual learning procedure for the model, based on receiving an indication or configuration from a network node different from the first node 210, based on changes in characteristics of the set of data samples (or the deployment environment), based on a change in conditions of a communications network associated with the second node (e.g., indicated by channel state information (CSI)), based on receiving an indication, from the first node 210, that indicates a quality of performance of the AI/ML model 225 at the first node 210 was below or outside of a threshold level of performance, and so on.

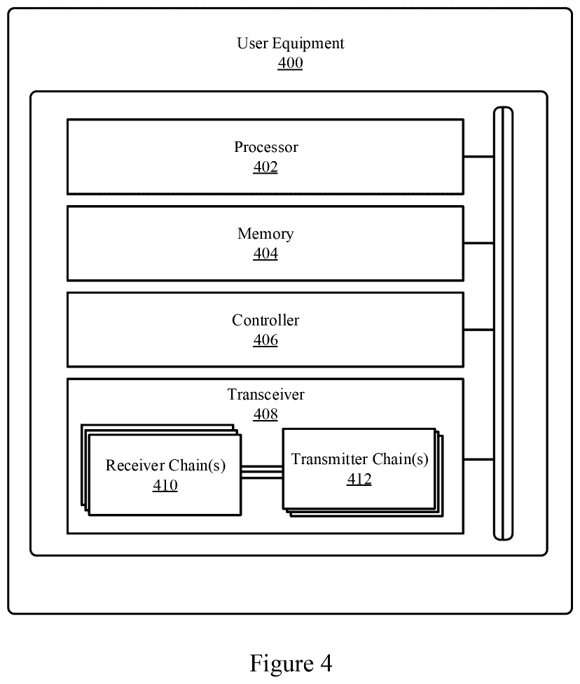

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to support a means for determining, for an AI/ML model, a set of knowledge intensive model parameters from a set of model parameters associated with the AI/ML model and based on a set of labeled data samples, and transmitting, to a second node, an indication of the set of knowledge intensive model parameters.

As another example, the processor 402 may support wireless communication at the UE 400 in accordance with examples as disclosed herein. The UE 400 may be configured to support a means for receiving, from a first node, an indication of a set of knowledge intensive model parameters, wherein the set of knowledge intensive model parameters are selected from a set of model parameters associated with an AI/ML model and updating the AI/ML model based on a set of data samples and by minimizing updates to the set of knowledge intensive model parameters.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

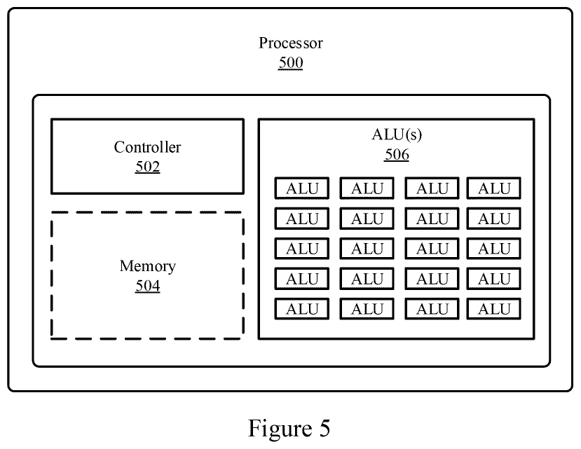

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support a means for determining, for an AI/ML model, a set of knowledge intensive model parameters from a set of model parameters associated with the AI/ML model and based on a set of labeled data samples, and transmitting, to a second node, an indication of the set of knowledge intensive model parameters.

As another example, the processor 500 may be configured to or operable to support a means for receiving, from a first node, an indication of a set of knowledge intensive model parameters, wherein the set of knowledge intensive model parameters are selected from a set of model parameters associated with an AI/ML model and updating the AI/ML model based on a set of data samples and by minimizing updates to the set of knowledge intensive model parameters.

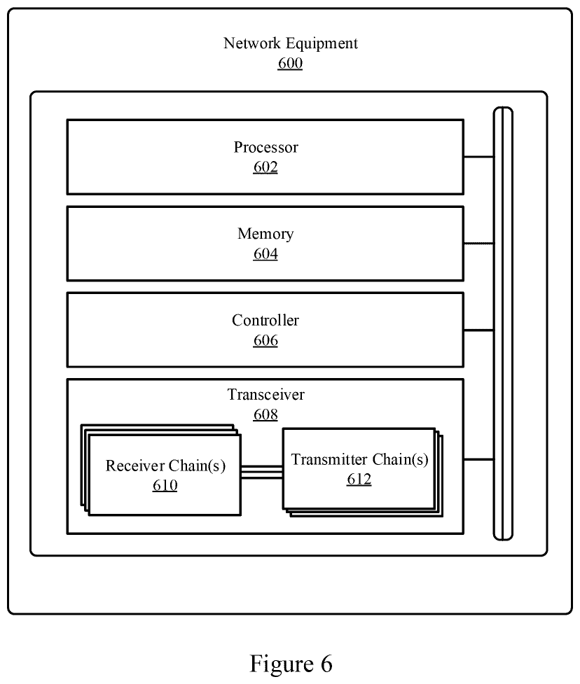

FIG. 6 illustrates an example of a NE 600 in accordance with aspects of the present disclosure. The NE 600 may include a processor 602, a memory 804, a controller 806, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to support a means for determining, for an AI/ML model, a set of knowledge intensive model parameters from a set of model parameters associated with the AI/ML model and based on a set of labeled data samples, and transmitting, to a second node, an indication of the set of knowledge intensive model parameters.

As another example, the NE 600 may be configured to support a means for receiving, from a first node, an indication of a set of knowledge intensive model parameters, wherein the set of knowledge intensive model parameters are selected from a set of model parameters associated with an AI/ML model and updating the AI/ML model based on a set of data samples and by minimizing updates to the set of knowledge intensive model parameters.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

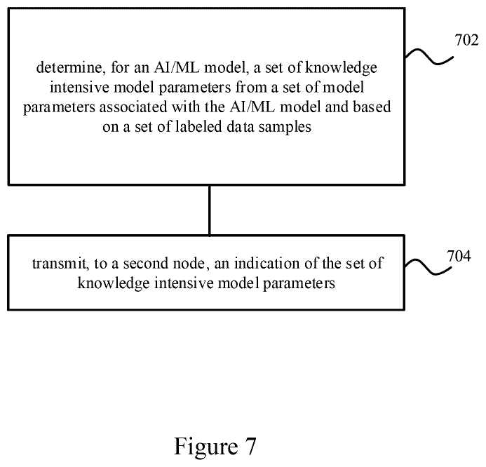

FIG. 7 illustrates a flowchart of a method in accordance with aspects of the present disclosure. The operations of the method may be implemented by a UE or an NE (e.g., as a first node) as described herein. In some implementations, the UE or the NE may execute a set of instructions to control the function elements of the UE or NE to perform the described functions.

At 702, the method may include determining, for an AI/ML model, a set of knowledge intensive model parameters from a set of model parameters associated with the AI/ML model and based on a set of labeled data samples. The operations of 702 may be performed in accordance with examples as described herein. In some implementations, aspects of the operations of 702 may be performed by a UE or an NE as described with reference to FIG. 4 or FIG. 6.

At 704, the method may include transmitting, to a second node, an indication of the set of knowledge intensive model parameters. The operations of 704 may be performed in accordance with examples as described herein. In some implementations, aspects of the operations of 704 may be performed a UE or an NE as described with reference to FIG. 4 or FIG. 6.

It should be noted that the method described herein describes a possible implementation, and that the operations and the steps may be rearranged or otherwise modified and that other implementations are possible.

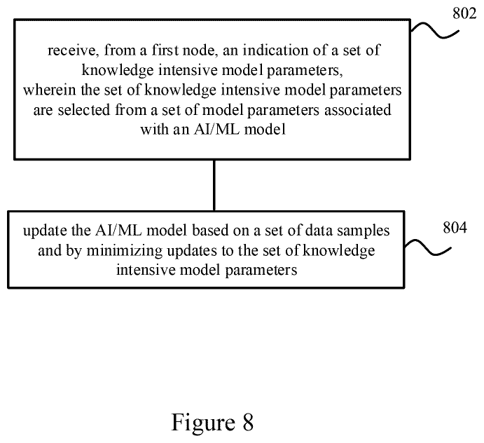

FIG. 8 illustrates a flowchart of a method in accordance with aspects of the present disclosure. The operations of the method may be implemented by an NE or a UE (e.g., as a second node) as described herein. In some implementations, the NE or the UE may execute a set of instructions to control the function elements of the NE or the UE to perform the described functions.

At 802, the method may include receiving, from a first node, an indication of a set of knowledge intensive model parameters, wherein the set of knowledge intensive model parameters are selected from a set of model parameters associated with an AI/ML model. The operations of 802 may be performed in accordance with examples as described herein. In some implementations, aspects of the operations of 802 may be performed by a UE or an NE as described with reference to FIG. 4 or FIG. 6.

At 804, the method may include updating the AI/ML model based on a set of data samples and by minimizing updates to the set of knowledge intensive model parameters. The operations of 804 may be performed in accordance with examples as described herein. In some implementations, aspects of the operations of 804 may be performed by a UE or an NE as described with reference to FIG. 4 or FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first node for wireless communication, comprising:
at least one memory; and
at least one processor coupled with the at least one memory and configured to cause the first node to:
determine, for an artificial intelligence/machine learning (AI/ML) model, a set of knowledge intensive model parameters from a set of model parameters associated with the AI/ML model and based on a set of labeled data samples; and
transmit, to a second node, an indication of the set of knowledge intensive model parameters.

2. The first node of claim 1, wherein, to determine the set of knowledge intensive model parameters, the at least one processor is configured to cause the first node to:
determine a knowledge coefficient value for each parameter in the set of model parameters; and
select a parameter in the set of model parameters as a knowledge intensive model parameter when an associated knowledge coefficient value is above a threshold value.

3. The first node of claim 2, wherein, to determine a knowledge coefficient value for each parameter, the at least one processor is configured to cause the first node to:
compute K number of gradient values with respect to the parameter,
wherein a gradient value corresponds to a distinct data sample in the set of labeled data samples;
compute K absolute values by computing an absolute value for each of the K number gradient values;
compute an average value of the computed K absolute values; and
determine the average value as the knowledge coefficient value for each parameter.

4. The first node of claim 1, wherein the at least one processor is further configured to cause the first node to receive the set of labeled data samples from a network node different from the second node.

5. The first node of claim 1, wherein the at least one processor is further configured to cause the first node to receive the set of labeled data samples based on reference signals received from a network node different from the second node.

6. The first node of claim 1, wherein, to transmit the indication of the set of knowledge intensive model parameters, the at least one processor is configured to cause the first node to transmit an indication that identifies one or more parameters of the set of model parameters as being part of the set of knowledge intensive model parameters.

7. A second node for wireless communication, comprising:
at least one memory; and
at least one processor coupled with the at least one memory and configured to cause the second node to:
receive, from a first node, an indication of a set of knowledge intensive model parameters,
wherein the set of knowledge intensive model parameters are selected from a set of model parameters associated with an artificial intelligence/machine learning (AI/ML) model; and
update the AI/ML model based on a set of data samples and by minimizing updates to the set of knowledge intensive model parameters.

8. The second node of claim 7, wherein, to update the AI/M model by minimizing updates to the set of knowledge intensive model parameters, at least one processor is configured to cause the second node to compute and minimize a loss function based on the set of data samples.

9. The second node of claim 7, wherein the at least one processor is further configured to cause the second node to receive the set of labeled data samples from a network node different from the first node.

10. The second node of claim 7, wherein the at least one processor is further configured to cause the second node to receive the set of labeled data samples based on reference signals received from a network node different from the first node.

11. The second node of claim 7, wherein the at least one processor is further configured to determine whether to update the AI/ML model based on receiving an indication of a periodic update interval.

12. The second node of claim 7, wherein the at least one processor is further configured to determine whether to update the AI/ML model based on receiving an indication or configuration from a network node different from the first node.

13. The second node of claim 7, wherein the at least one processor is further configured to determine whether to update the AI/ML model based on changes in characteristics of the set of data samples.

14. The second node of claim 7, wherein the at least one processor is further configured to determine whether to update the AI/ML model based on a change in conditions of a communications network associated with the second node.

15. The second node of claim 7, wherein the at least one processor is further configured to determine whether to update the AI/ML model based on receiving an indication, from the first node, that indicates a quality of performance of the AI/ML model at the first node.

16. The second node of claim 7, wherein a knowledge intensive model parameter is associated with a knowledge coefficient value above a threshold value.

17. A method performed by a first node, the method comprising:
determining, for an artificial intelligence/machine learning (AI/ML) model, a set of knowledge intensive model parameters from a set of model parameters associated with the AI/ML model and based on a set of labeled data samples; and
transmitting, to a second node, an indication of the set of knowledge intensive model parameters.

18. The method of claim 17, wherein determining the set of knowledge intensive model parameters further comprises:
determining a knowledge coefficient value for each parameter in the set of model parameters; and
selecting a parameter in the set of model parameters as a knowledge intensive model parameter when an associated knowledge coefficient value is above a threshold value.

19. A method performed by a second node, the method comprising:
receiving, from a first node, an indication of a set of knowledge intensive model parameters,
wherein the set of knowledge intensive model parameters are selected from a set of model parameters associated with an artificial intelligence/machine learning (AI/ML) model; and
updating the AI/ML model based on a set of data samples and by minimizing updates to the set of knowledge intensive model parameters.

20. The method of claim 19, wherein updating the AI/M model by minimizing updates to the set of knowledge intensive model parameters includes computing and minimizing a loss function based on the set of data samples.
